(19) United States
(12) Patent Application Publication
(10) Pub. No.: US 2002/0056105 A1
(43) Pub. Date: May 9, 2002

(54) Method and system for providing additional information to an advertisement being viewed

(76) Inventors: Ming Wei, Los Altos, CA (US); Yousheng Cao, Mt. View, CA (US)

Correspondence Address: Ming Wei, 1171 S. Springer Road, Los Altos, CA, 94024, US

(21) Appl. No.: 09/780,167

(22) Filed: Feb. 9, 2001

Related U.S. Application Data
(60) Provisional application No. 60/181,415, filed on Feb. 9, 2000.

(51) Int. Cl. H04N 7/025

(52) U.S. Cl. 725/42

(57) ABSTRACT

A system and method are provided for commercial message viewers or listeners to have ability to obtain additional information in a separate channel to a commercial message being viewed in a primary channel so that an advertiser of the commercial message does not have to pay for the time of the additional information in the primary channel. The viewers or listeners upon viewing or listening the commercial message on receivers can click on the advertisement to obtain additional information.

### BACKGROUND OF THE INVENTION

1. Field of the Invention

The present invention generally relates to the area of television broadcasting systems and more particularly relates to methods and systems for providing additional information in a separate channel to a commercial message being viewed in a primary channel so that an advertiser of the commercial message does not have to pay for the time of the additional information in the primary channel.

2. Description of the Related Art

In today's society, television may provide the most available broadcast medium that can reach almost every one in the United States through cable or air transmission. Because of the unparalleled penetration to consumers, the television and cable network is particularly advantageous to transmit a great volume of commercial information to viewers, often interlaced in or between regular television programs. Many businesses including manufacturers and retailers spend collectively billions of dollars each year to advertise their services and products on television. In practice, the more special a program is, the more expensive to insert in an advertisement. Further the more popular a television channel is, the more expensive it is to advertise thereon. For example, it is far more expensive to put on a 30-second advertisement on CNN, ABC or NBC than a 30-minute advertisement on a local channel. Therefore, many of the businesses have to shorten the advertisement when the advertisement is prepared for the major channels to cut down the cost. However, one of the side-effects for a shortened advertisement is a significantly decreased attention from the viewers and, quite often, the viewers do not even understand what is being actually advertised in a 30-second or less footage.

There is therefore a great need for solutions that permit advertisers to provide detailed advertisements to viewers of those major television channels without incurring substantially increased costs.

### DETAILED DESCRIPTION OF THE PREFERRED EMBODIMENTS

In the following description along with the appendix of the present invention, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well known methods, procedures, components, and circuitry have not been described in detail to avoid unnecessarily obscuring aspects of the present invention.

Annexed hereto is a six-page specification, entitled “Method and Apparatus for Linking Programs or Information in Different TV or Radio Broadcast Channels for Broadcasters and Advertisers”, teaching and referring to the detailed design, features, use, advantages, configurations and characteristics of the system according to one embodiment of the present invention. The appendix shall be referenced and understood in conjunction with the following description of the present invention and should not be interpreted as any implied limitations, if there are any, in the present invention.

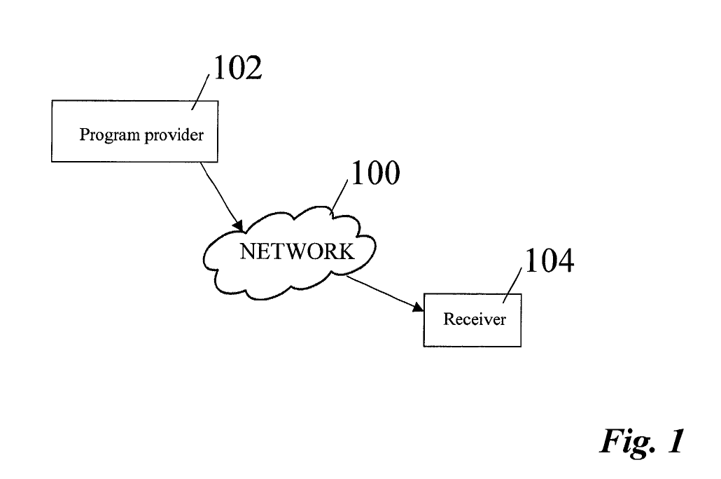

Referring now to the drawings, in which like numerals refer to like parts throughout the several views. FIG. 1 illustrates an exemplary configuration in which the present invention may be practiced. Medium 100 represents a communication means that facilitates program transmission from program provider 102 to receiver 104 and may include, but not be limited to, air transmission, cable transmission and Internet transmission. Program provider 102 represents one of TV stations, radio stations, or computer servers coupled to medium 100 and provides broadcasting services that includes, but not be limited to news, entertainment, data information and commercial messages. Receiver 104 represents one of numerous types of receiving devices that are capable of receiving the broadcasting services from program provider 102. One of the typical examples of receiver 104 is a modified Television. As used herein, a modified television is equipped with a memory function that stores footage of a predefined length and can be achieved by attaching a periphery to a regular TV. The periphery, as will be further described below, includes a memory to store a segment of the program being played on the TV. It is understood to those skilled in the art that emerging digital TV or a computing device (e.g. a personal computer) will have such memory internally and hence no need for such periphery.

To facilitate the description of the present invention, the description in the foregoing and following is focused on television sets and corresponding television programs that may or may not include commercial advertisement or messages. It will be evident that the description can be equally applied to radio sets and corresponding radio programs as well as computing devices and corresponding data broadcasting services.

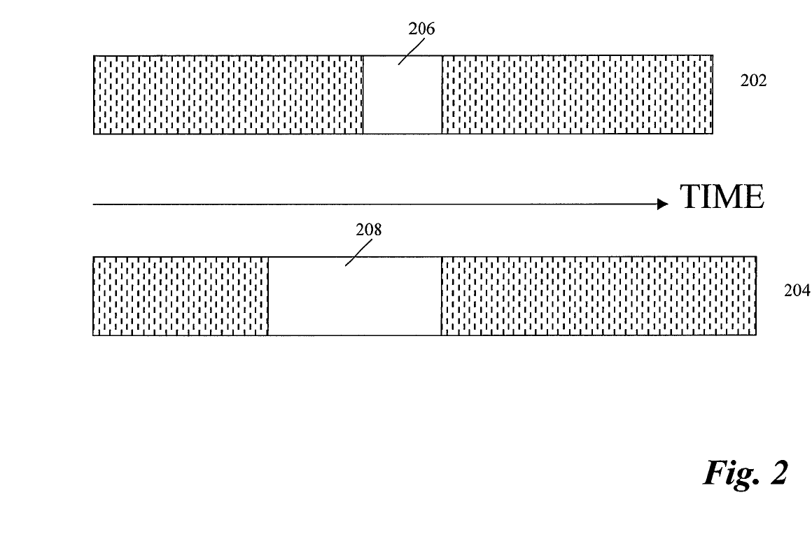

Referring now to FIG. 2, there are respectively shown two TV programs being broadcast through the same medium and typically from the same program provider. It is assumed that program 202 being broadcast is on a major channel while program 204 being broadcast is on a secondary channel. Programs 202 and 204, each include an advertisement 206 and 208 respectively. According to one aspect of the present invention, advertisement 206 and 208 belong to one advertiser and advertise the same thing, e.g. a product or a server, except advertisement 206 is brief and advertisement 208 is detailed. As the major channel charges a lot more for the same time of the advertisement that runs on the secondary channel, advertisement 206 is significantly shortened and brief while advertisement 208 is more detailed and lengthy.

It should be noted that a secondary channel does not have to provide a program that is inserted or interlaced with one or more advertisement footage. For example, the secondary channel delivers only commercial messages or data to complement other channels with more detailed information.

As is known that the major channel attracts more viewers, shortened advertisement 206 may catch an attention from the viewers but often fail to get the viewers understood what is being described in the advertisement. According to one embodiment of the present invention, advertisement 208 can be configured to be broadcast at the same time but in a secondary channel that is provided for those viewers that get interested in advertisement 206 to turn to advertisement 208. According to another embodiment of the present invention, a sequence of advertisements including advertisement 208 are delivered periodically and asynchronously with respect to the primary channel. In other words, the detailed versions of the advertisements are fed to the secondary channel and, preferably, stored in a local memory that can be accessed upon request.

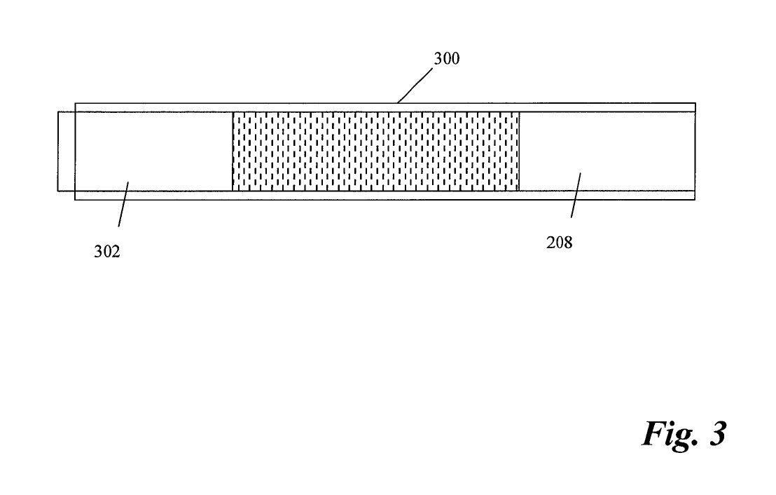

According to one embodiment of the present invention, program 204 is configured to pass through a buffer memory in the TV. FIG. 3 illustrates such buffer memory 300 according to one embodiment. Program 204 is made to feed through memory 300. When advertisement 208 arrives at the end of memory 300, corresponding advertisement 206 starts to be played. When a viewer sees advertisement 206 and decides to see more of the advertisement, he/she may press a predefined key in a remote controller that activates a link embedded in program 202, preferred in the segment that carries advertisement 206. That link causes the content in buffer memory 300 to be played on the TV as soon as the link is activated. As a result, the viewer of the major channel gets the opportunity to view the detailed version while the advertiser does not have to pay for the detailed version that would otherwise be run on the major channel. The detailed implementation according to one embodiment is provided in the Appendix.

One of the key features in the present invention is to attract the large audience enjoyed by a major or primary channel to a corresponding detailed advertisement being broadcast on a secondary channel. In reality, not only does an advertiser benefit from the saving while enjoying the large audience from a major channel, but also the viewers benefit from a shortened advertisement run on a major channel that typically provide more entertainment or news information.

The processes, sequences or steps and features discussed above and in the appendix are related to each other and each is believed independently novel in the art. The disclosed processes and sequences may be performed alone or in any combination to provide a novel and unobvious system or a portion of a system. It should be understood that the processes and sequences in combination yield an equally independently novel combination as well, even if combined in their broadest sense; i.e. with less than the specific manner in which each of the processes or sequences has been reduced to practice in the attached appendixes.

While the embodiment discussed herein or in the appendix may appear to include some limitations as to the presentation of the advertisement, in terms of the format and arrangement, the invention has applicability well beyond such embodiment, which can be appreciated by those skilled in the art.

The forgoing and attached are illustrative of various aspects/embodiments of the present invention. The disclosure of specific sequence/steps and the inclusion of specifics with regard to broader methods and systems are not intended to limit the scope of the invention which finds itself in the various permutations of the features disclosed and described herein as conveyed to one of skill in the art.

1. A method of providing associated Information to an advertisement program being accessed through a receiver, the method comprising:
providing the associated information in a first channel;
the associated information going through a buffer of a receiver;
providing the advertisement program in a second channel;
the advertisement program being accessed on the receiver and including a linking code to the buffer;
wherein contents of the buffer are immediately played on the receiver as soon as a user causes to activate the linking code.

2. The method of claim 1, wherein the contents of the buffer are the associated Information of the advertisement program in the second channel

3. The method of claim 2, wherein the receiver is selected from a group consisting of a TV set, TV set-top box, a radio set and a computing device with multi-channel receiving capability and buffer memory or storage capability.

4. The method of claim 2, wherein the contents of the buffer are updated continuously.

5. The method of claim 1, wherein said method further comprises:
managing the contents in the buffer so a selected content is saved, deleted, or retrieved by the user.

6. The method of claim 1, wherein the linking code is the associated information address.

7. In an advertisement broadcast system having a plurality of different channels carrying various programs, the programs are streamed to a plurality of users over the channels, said the advertisement broadcast system comprising:
a program content manager, said program content manager operates to customize an advertisement program and its associated information with a linking code;
a program management system operatively receives program contents from said program content manager, schedules delivery of the program contents from said program content manager to broadcasting channels by setting up the advertisement program to be broadcasted in one channel and its associated information to be broadcasted in a different channel; and
a program delivery hardware operatively connecting said program management system to the channels to facilitate the delivery of contents from said program content manager to users.

8. An advertisement broadcast system as recited in claim 7, wherein the channels are computer network, TV cable network, telephone network, or air.

9. An advertisement broadcast system as recited in claim 7, wherein a channel is used to delivery associated information of the advertisement programs in other one or more channels.

10. An advertisement broadcast system as recited in claim 7, wherein the linking code is the associated information address.
